(19) United States
(12) Patent Application Publication
(10) Pub. No.: US 2003/0154605 A1
(43) Pub. Date: Aug. 21, 2003

(54) Craft knife having interchangeable blades

(76) Inventor: Chien-Chuan Chao, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/077,865

(22) Filed: Feb. 20, 2002

(51) Int. Cl. B26B 1/08

(52) U.S. Cl. 30/162

(57) ABSTRACT

A craft knife having interchangeable blades includes a housing, and a controlling piece moveably received in the housing. A receiving chamber is defined in an interior of the housing for receiving blades. A resilient member is disposed in the interior of the housing to provide a resilience pushing the blades such that one of the blades is urged to be received in a receiving recess defined on the controlling piece. In operation of the craft knife, the controlling piece is able to be slid so that the blade received in the receiving recess is slid out of the housing and detached from the controlling piece, moreover, the controlling piece is able to be slid back into the housing so that another one of the blades in the receiving chamber is able to be pushed into the receiving recess for replacing the detached blade.

### BACKGROUND OF THE INVENTION

1. Field of the Invention

The present invention relates to a craft knife, and more particularly to a craft knife having interchangeable blades.

2. Description of Related Art

Craft knifes are widely used to perform various kinds of cutting. One kind of the craft knife is designed primarily for use in carpentry. In order to cut wooden materials, this kind of craft knife is equipped with a thick blade and the blade is typically trapezoidal in shape. During operation, the blade is pushed to protrude out of a housing of the craft knife so that a user can use a sharp edge of the blade or more precisely a tip of the sharp edge to perform cutting. However, after operating several times, the tip will gradually become blunt. To overcome this problem, some conventional craft knifes having blades that can be partly snapped away so as to form new sharp edges and tips. Nevertheless, as mentioned before, the blade of craft knife used in carpentry is thick and cannot be easily broken by hand. Therefore, once the tip of the sharp edge becomes blunt, the user has to open the housing and turn the blade around so that the other tip of the sharp edge originally received in the housing can now be pushed out of the housing for cutting. Surely, if both tips become blunt, the blade must be replaced. Therefore, in practical use, a box containing blades for replacement needs to be brought along with the user. Moreover, the procedures related to the replacement of the blade are complicated. Accordingly, the user often complains about the inconvenience of the craft knife used in carpentry.

Therefore, the present invention intends to provide a craft knife having interchangeable blades to mitigate and/or obviate the aforementioned problems.

### SUMMARY OF THE INVENTION

The objective of the present invention is to provide a craft knife having interchangeable blades so that once a blade becomes blunt, the blade can be conveniently replaced by other blades received in a housing of the craft knife.

Other objectives, advantages and novel features of the invention will become more apparent from the following detailed description when taken in conjunction with the accompanying drawings.

To achieve the forgoing objectives a craft knife in accordance with the present invention has a housing having a front open end and a receiving chamber defined in an interior of the housing for receiving multiple blades. A controlling piece is moveably received in the interior of the housing and extendable out of housing via the front open end, and a receiving recess is defined on a side of the controlling piece. A resilient member is disposed in the interior of the housing to provide a resilience pushing the blades such that one of the blades is urged to be received in the receiving recess defined in the controlling piece. In operation of the craft knife, the controlling piece is able to be slid so that the blade received in the receiving recess is slid out of the housing and detached from the controlling piece. Moreover, the controlling piece is able to be slid back into the housing so that another one of the blades in the receiving chamber is able to be pushed into the receiving recess for replacing the detached blade.

### BRIEF DESCRIPTION OF THE DRAWINGS

FIG. 1 is a perspective view of a craft knife having interchangeable blades in accordance with the present invention, wherein an operational blade is retracted inside a housing of the craft knife;

FIG. 2 is a perspective view of the craft knife, wherein the operating blade is pushed to protrude out of the housing for cutting;

FIG. 3 is a perspective view of the craft knife, wherein a controlling piece is pushed to protrude out of the housing for replacing the operating blade;

FIG. 4 is an exploded, perspective view of the craft knife;

FIG. 5 is a perspective view showing a lateral side of the controlling piece, wherein the side has a receiving recess defined therein for the operational blade;

FIG. 6 is a schematic, plane view showing the craft knife under the condition in FIG. 1, wherein a second piece of the housing is detached from the craft knife;

FIG. 7 is a schematic, plane view of the craft knife while the second piece is detached to show the controlling piece at a position between the retracted and the protruded positions respectively corresponding to FIGS. 6 and 8;

FIG. 8 is a schematic, plane view showing the craft knife under the condition in FIG. 2, wherein the second piece of the housing is detached from the craft knife;

FIG. 9 is a schematic, plane view showing the craft knife under the condition in FIG. 3, wherein the second piece of the housing is detached from the craft knife;

FIG. 10 is a schematic, cross-sectional view of the craft knife taken along line 10-10 in FIG. 1; and

FIG. 11 is a schematic, cross-sectional view of the craft knife taken along line 11-11 in FIG. 1.

### DETAILED DESCRIPTION OF THE PREFERRED EMBODIMENT

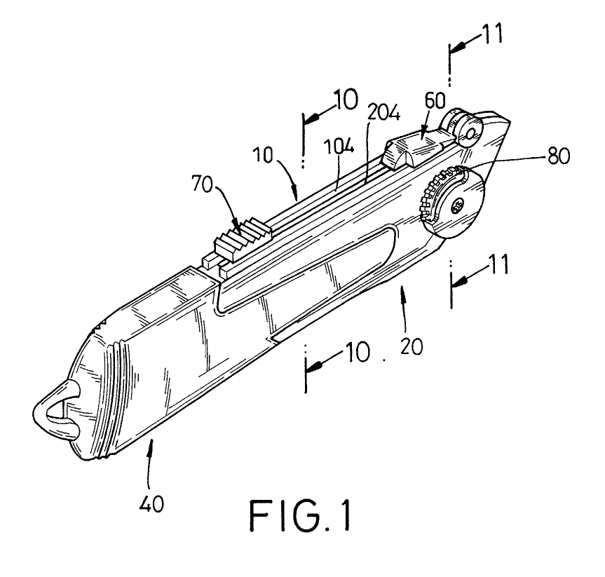

With reference to FIG. 1, a craft knife having interchangeable blades in accordance with the present invention includes a first piece (10), a second piece (20) and a tail barrel (40) such that these three pieces (10, 20 and 40) are combined together to form a housing of the craft knife. A button (70) is mounted on top of the housing and moveable along a gap consisting of a first sliding slot (104) defined in the first piece (10) and a second sliding slot (204) defined in the second piece (20). A cap (60) is pivotally mounted at a front end of the gap. A wheel (80) is rotatably mounted on the second piece (20) and near a front end of the housing.

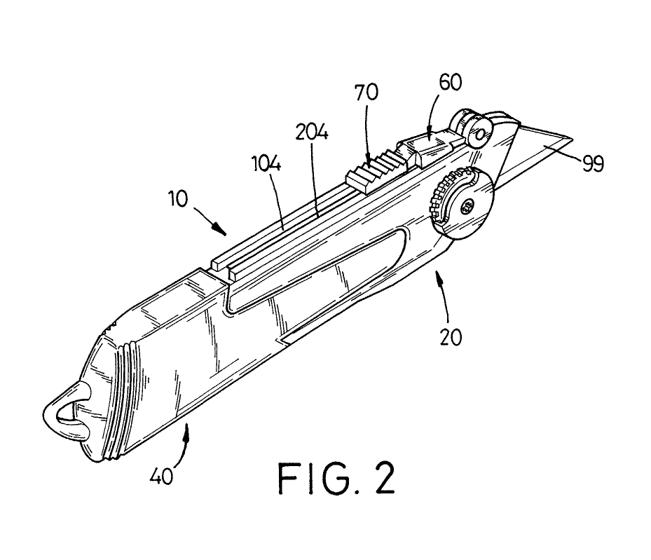

With reference to FIG. 2, when the button (70) is slid to abut the cap (60), an operational blade (99) protrudes out of the front end of the housing. It is noted that due to the button (70) being abutted to the cap (60), the blade (99) only protrudes a predetermined length out of the housing so that a sharp tip of the blade can be used for cutting.

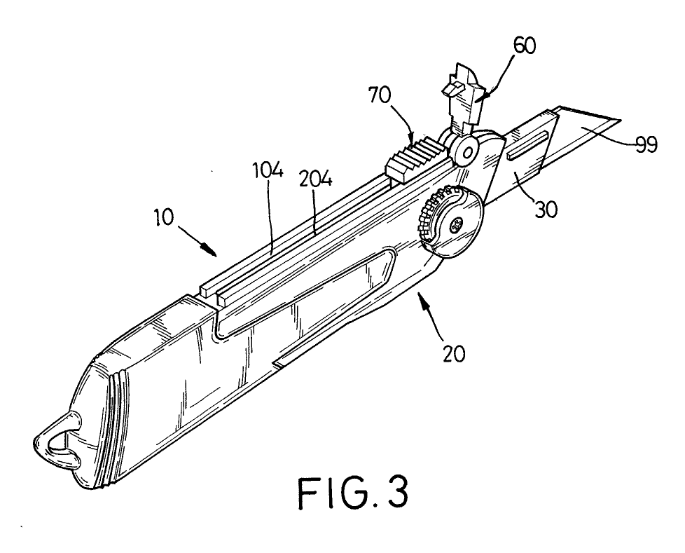

With reference to FIG. 3, when the cap (60) is pivoted upwardly relative to the housing, the button (70) can be further slid to the frontmost end of the of the gap to protrude a controlling piece (30) out of the front end of the housing. At this moment, the blade (99) can be separated from the controlling piece (30).

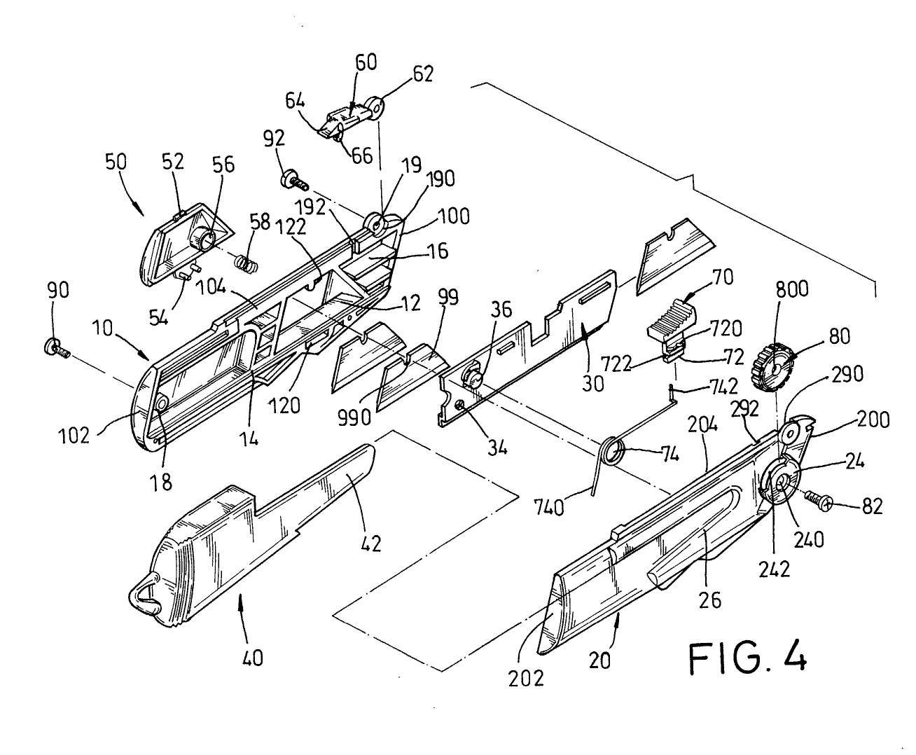

With reference to FIG. 4, the first piece (10) has a front open end (100) and a rear closed end (102). The first sliding slot (104) is defined through a top surface of the first piece (10). A receiving chamber (12) is defined through and substantially at a middle section of the first piece (10) for receiving additional blades (99). A retaining slot (120) is defined through the first piece (10) and below the receiving chamber (12). A retaining protrusion (122) is formed on a top periphery defining the receiving chamber (12). A sliding groove (14) is defined in an inner surface of the first piece (10) from the front open end (100) to the rear closed end (102). Multiple guiding ridges (16) are formed between the receiving chamber (12) and the front open end (100). A first securing hole (18) is defined through the rear closed end (102). A first connecting hole (19) is defined through the front open end (100) and located on the top surface of the first piece (10). A first recess (190) is defined next to the first connecting hole (19). A first bore (192) is defined through the top surface of the first piece (10) and located between the first connecting hole (19) and the receiving chamber (12).

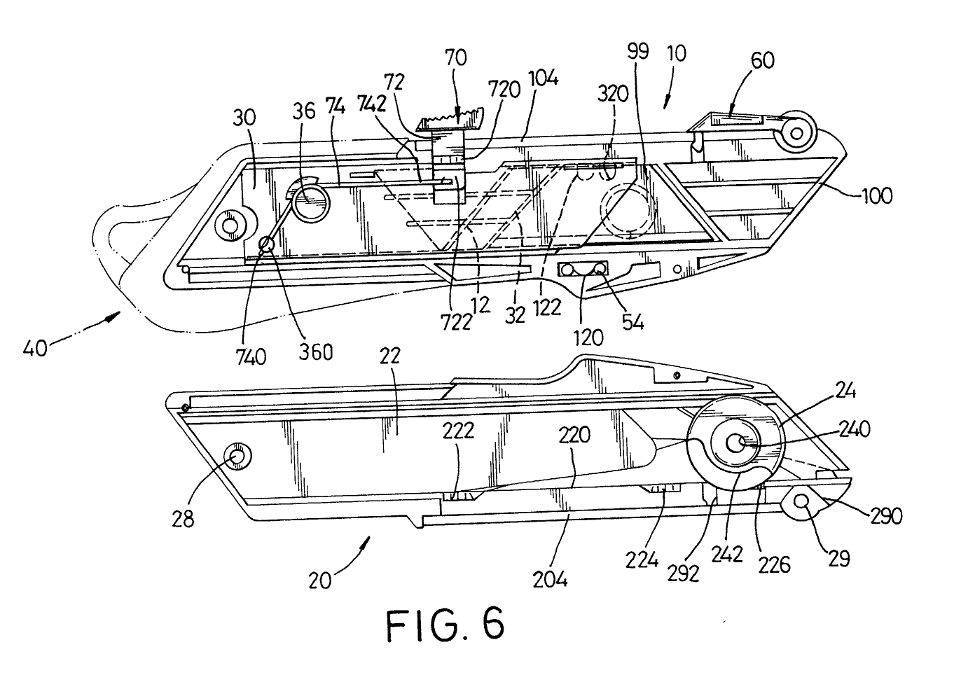

With reference to FIGS. 4 and 6, the second piece (20) has a front open end (200) and a rear closed end (202). The second sliding slot (204) is defined through a top surface of the second piece (20) to correspond to the first sliding slot (104). A concavity (22) is defined on an inner surface of the second piece (20). A guiding edge (220) is formed along a periphery defining the concavity (22) and located close to the second sliding slot (204). An inner socket (222), a middle socket (224), and an outer socket (226) are respectively defined on the guiding edge (220) and theses sockets (222, 224 and 226) are spaced apart proper distances. More specifically, among these sockets (222, 224 and 226), the outer socket (226) is located nearest the front open end (200) and the inner socket (222) is located nearest the closed end (202). A region of the second piece (20) near the front open end (200) is convex outwardly so as to define a hollow (24) for receiving the wheel (80), and a screw hole (240) is centrally defined through the region. A notch (242) is also defined through the region to communicate with the hollow (24). A recessed surface (26) is formed on an outer surface of the second piece (20). A second securing hole (28) is defined in the rear closed end (202) to correspond to the first securing hole (18). A second connecting hole (29) is defined through the front open end (200) to correspond to the first connecting hole (19). A second recess (290) is defined on the top surface of the second piece (20) to correspond to the first recess (190). A second bore (292) is defined through the top surface of the second piece (20) to correspond to the first bore (192).

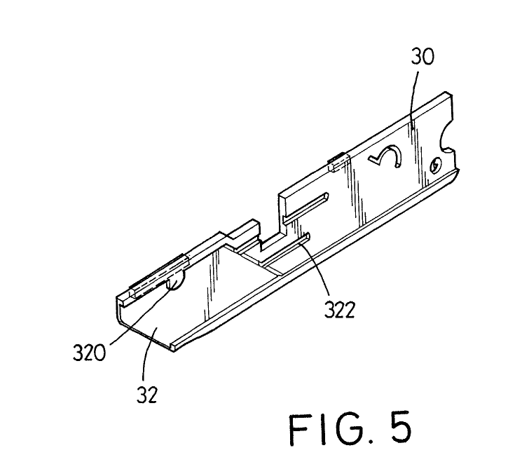

The controlling piece (30) is assembled in the concavity (22) defined in the second piece (20) (shown in FIG. 6) to be disposed between the first piece (10) and the second piece (20). With reference to FIG. 5, the controlling piece (30) has a side facing the first piece (10) and a receiving recess (32) is defined on that face. The receiving recess (32) is configured to have a depth corresponding to a thickness of one blade (99). A securing boss (320) is formed on a top edge defining the receiving recess (32). Multiple guiding grooves (322) are defined in said face of the controlling piece (30) and next to the receiving recess (32) to mate the guiding ridges (16) of the first piece (10). Referring to FIG. 4, the controlling piece (30) has another side facing the second piece (20). A peg (36) and a hook (34) are respectively formed on this side.

The tail barrel (40) is to be mounted around the rear closed ends (102 and 202) of the first piece (10) and the second piece (20) so that a user can comfortably hold the craft knife. A securing piece (42) integrally extends from the tail barrel (40) to be received in the recessed surface (26).

Still referring to FIG. 4, a cover (50) is detachably connected to the first piece (10) to cover an opening communicating the receiving chamber (12). A protuberance (52) is formed on a top edge of the cover (50) and multiple pins (54) extend from a bottom edge of the cover (50). Therefore, the cover (50) is able to be connected to the first piece (10) by clamping the protuberance (52) to an edge defining the opening communicating the receiving chamber (12) and inserting the pins (54) into the retaining slot (120). Furthermore, a sleeve (56) extends from the cover (50) to be received in the receiving chamber (12). A resilient member (58) is disposed in the sleeve (56) and the resilient member (58) is preferably a spring as shown in the figures.

The cap (60) having an end defined with an aperture (62) and the other end configure to form an abutting end (64). A connecting screw (92) is screwed into the first connecting hole (19), the aperture (62) and the second connecting hole (29) so as to pivotally connect the cap (60) to the housing. A column (66) extends from a bottom surface of the cap (60) to be received in the first bore (192) and the second bore (292).

The button (70) has a wing (72) formed on a bottom side thereof to be extended into the gap defined by the combined first sliding slot (104) and second sliding slot (204). Multiple teeth (720) are formed on a side of the wing (72). A slit (722) is defined through the wing (72).

A torsional spring (74) is mounted around the peg (36) of the controlling piece (30), and has an abutting end (740) and a connecting end (742). The abutting end (740) is to be abutted to the hook (34) of the controlling piece (30) and the connecting end (742) is to be coupled in the slit (722) defined in the wing (72) of the button (70).

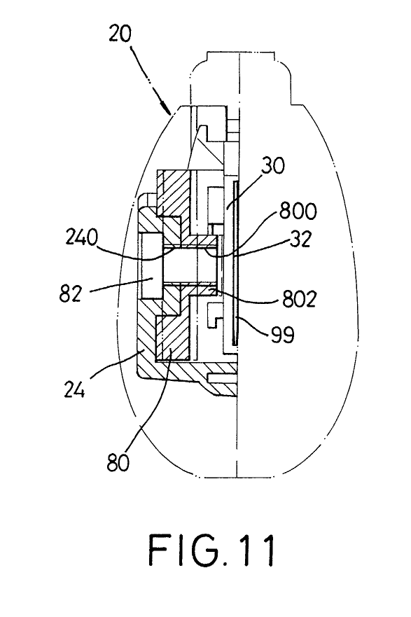

With reference to FIGS. 4 and 11, the wheel (80) has a threaded hole (800) defined therein, and a cylinder (802) extending from a side thereof. An axial screw (82) is securely mounted in the screw hole (240). The wheel (80) is further screwed onto the axial screw (82) via the threaded hole (800) so that the wheel (80) is rotatably mounted in the hollow (24) defined in the second piece (20) while the cylinder (802) extends toward the first piece (10).

A securing screw (90) is to be screwed into the first securing hole (18) and the second securing hole (28) to combine the first piece (10) and the second piece (20) together.

The additional blades (99) are received in the receiving chamber (12) defined in the first piece (10). A cutout (990′) is defined in a top edge of each blade (99) so as to mate the retaining protrusion (122).

With reference to FIG. 6, when the controlling piece (30) is fully retracted in the housing, due to a resilience provided by the torsional spring (74), the button (70) is urged upwardly to a position such that the teeth (720) are secured in the inner socket (222).

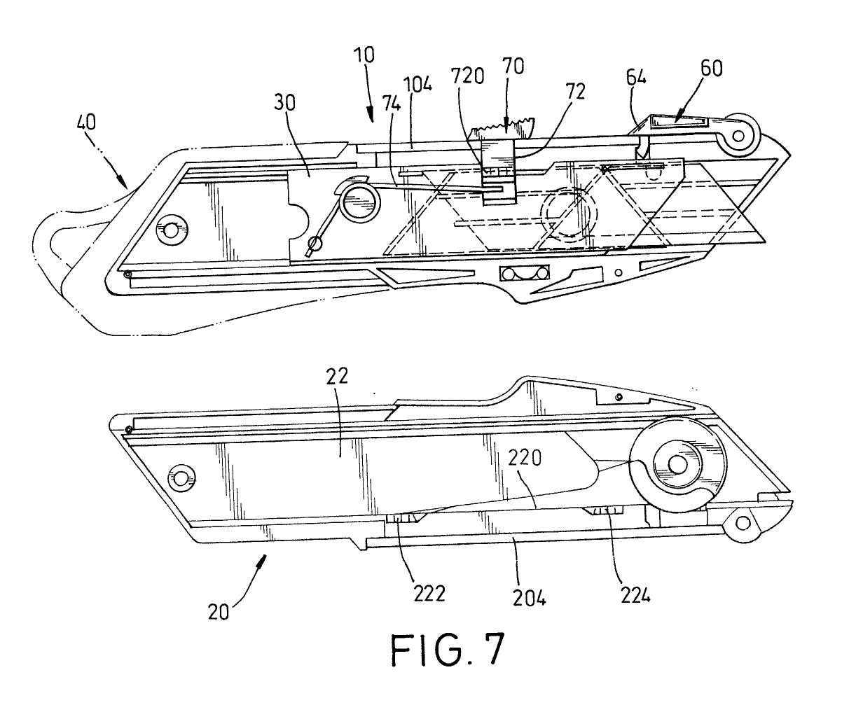

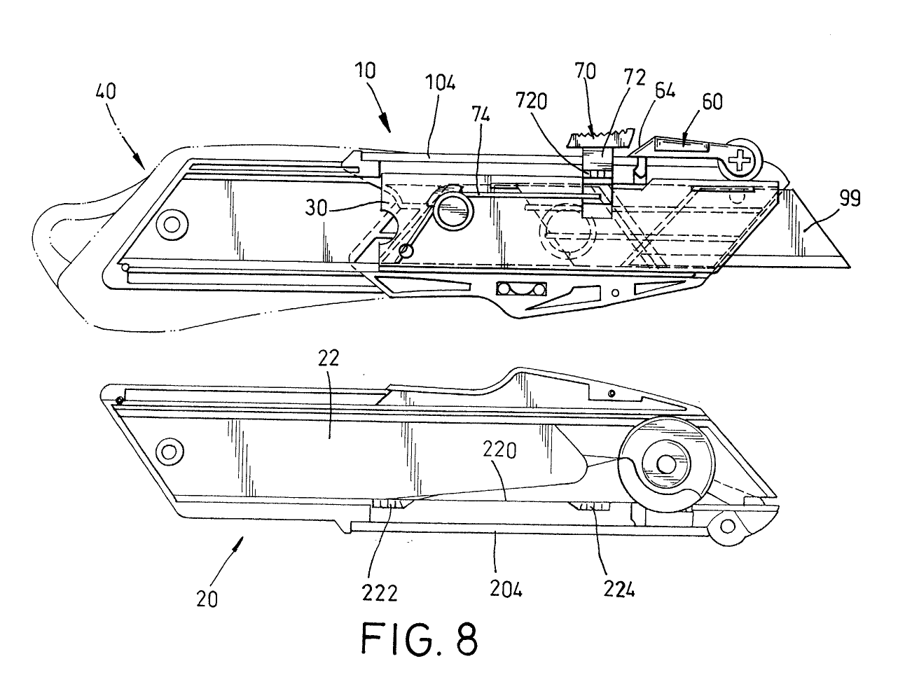

With reference to FIG. 7, to protrude the operational blade (99) out of the housing, the button (70) has to be pressed so as to disengage the teeth (720) and the inner socket (222). Once the button (70) is slid and abutted to the cap (60), the button is released. Again, due to the resilience, the button (70) is urged upwardly such that the teeth (720) are secured in the middle socket (224) as shown in FIG. 8. At this moment, the operational blade (99) protrudes the predetermined length out of the housing and is ready to perform cutting. It is noted due to the mating of the teeth (720) in the middle socket (224), the controlling piece (30) together with the operation blade (99) is secure to the current position and will not slide undesirably during cutting.

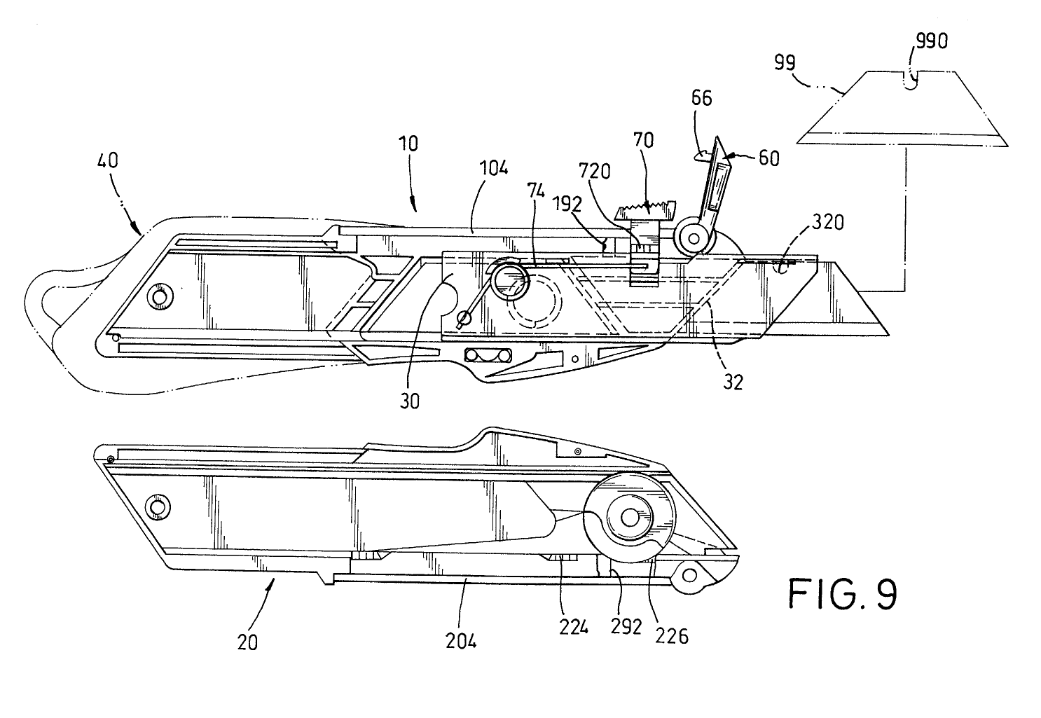

To replace the operation blade (99) after it becomes blunt, the cap (60) is pivoted upwardly, and the button (70) is pressed to disengage the teeth (720) and the middle socket (224). Furthermore, the button (70) is slid to the frontmost end of the gap combined of the first sliding slot and the second sliding slot (204) so that when the button (70) is released, the teeth (720) are received in the outer socket (226) due to the resilience as shown in FIG. 9. At this moment, the operational blade (99) is completely outside the housing and can be pushed toward aside to detach from the controlling piece (30).

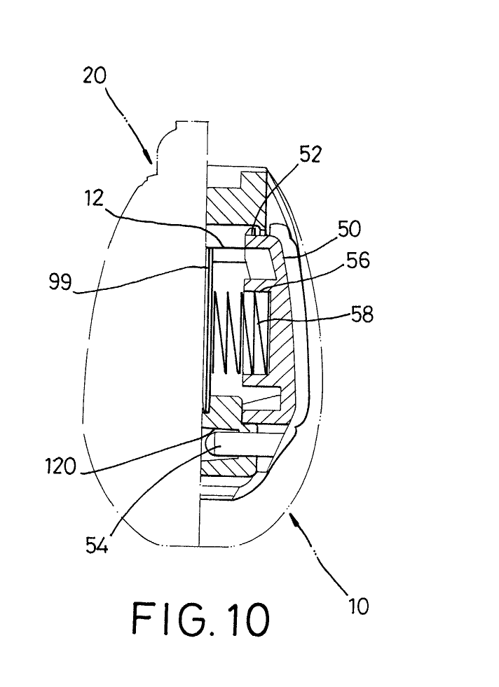

Once the operational blade (99) is detached, the controlling piece (30) can be fully retracted into the housing to be in the state shown in FIG. 6. As shown in FIG. 10, the additional blades (99) will be pushed by the resilient member (58) toward the controlling piece (30). Accordingly, one of the additional blades (99) that is closest to the controlling piece (30) will be urged into the receiving recess (32) while the securing boss (320) mates the cutout (990′) defined in that blade (99). Therefore, the blunt operational blade (99) is replaced by a new blade. It is to be noted that the space between edges of the ridges (16) and a surface defining the receiving recess (32) is only enough for one blade to pass through. Hence, other additional blades (99) not received in the receiving recess (32) will be restricted in the receiving chamber (12) during the sliding moment of the controlling piece (30).

With reference to FIG. 11, it is to be noted that when the controlling piece (30) is slid to the position shown in FIG. 8, the operational blade (99) is ready for cutting. The wheel (80) can be rotated to approach the cylinder (802) to the side of the controlling piece (30) until the cylinder (802) is firmly engaged with the controlling piece (30). Simultaneously, the operational blade (99) is securely clamped between the guiding ridges (16) and the surface defining the receiving recess (32). Therefore, the operational blade (99) is prevented from shaking undesirably during cutting.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A craft knife comprising:
a housing having a front open end and a receiving chamber defined in an interior of the housing for receiving multiple blades,
a controlling piece moveably received in the interior of the housing and extendable out of the housing via the front open end, a receiving recess defined in a side of the controlling piece; and
a resilient member disposed in the interior of the housing to provide resilience pushing the blades such that one of the blades is urged to be received in the receiving recess defined on the controlling piece,
whereby the controlling piece is able to be slid so that the blade received in the receiving recess is slid out of the housing and detached from the controlling piece, moreover, the controlling piece is able to be slid back into the housing so that another one of the blades in the receiving chamber is able to be pushed into the receiving recess for replacing the detached blade.

2. The craft knife as claimed in claim 1, wherein the housing has an opening defined therein and communicating with the receiving chamber, and a cover is detachably connected to the housing for covering the opening.

3. The craft knife as claimed in claim 2, wherein the cover further has a sleeve formed thereon for receiving the resilient member.

4. The craft knife as claimed in claim 1 further comprising a tail barrel mounted around a rear end of the housing so that a user is able to comfortably hold the tail barrel during an operation of the craft knife.

5. The craft knife as claimed in claim 1 further comprising a button connected to the controlling piece and moveably mounted on an outer surface of the housing.

6. The craft knife as claimed in claim 5 further comprising a torsional spring connected between the controlling piece and the button.

7. The craft knife as claimed in claim 6, wherein the button has at least one tooth formed thereon, an inner socket, a middle socket and an outer socket are defined in an inner surface of the housing to mate the at least one tooth.

8. The craft knife as claimed in claim 7, wherein the torsional spring has a connecting end and an abutting end formed thereon, the connecting end is coupled to the button and the abutting end is abutted to a hook formed on the controlling piece.

9. The craft knife as claimed in claim 5 further comprising a cap pivotally connected near the front end of the housing for restricting the movement of the button.

10. The craft knife as claimed in claim 1, wherein the resilient member is a spring.

11 The craft knife as claimed in claim 1, wherein the housing is combined of a first piece and a second piece.

12. The craft knife as claimed in claim 1 further comprising an axial screw securely mounted on the housing, a wheel threadingly mounted around the axial screw and has a cylinder extending from a side of the wheel, whereby the wheel is able to be rotated so as to firmly engage the cylinder with the controlling piece.

13. The craft knife as claimed in claim 1, wherein the controlling piece has a securing boss formed on an edge defining the receiving recess to mate a cutout defined in the blade received in the receiving recess.
